(19) United States
(12) Patent Application Publication
(10) Pub. No.: US 2025/0220791 A1
(43) Pub. Date: Jul. 3, 2025

(54) OPERATING FREQUENCY CONTROL FOR LIGHT EMITTING ELEMENT DRIVING CIRCUIT

(71) Applicant: Chengdu Monolithic Power Systems Co., Ltd., Chengdu (CN)

(72) Inventor: Zilin Fan, Hangzhou (CN)

(21) Appl. No.: 19/002,433

(22) Filed: Dec. 26, 2024

(30) Foreign Application Priority Data
Dec. 27, 2023 (CN) 202311832245.6

(51) Int. Cl. H05B 45/3725

(52) U.S. Cl. CPC H05B 45/3725

(57) ABSTRACT

A control circuit for a light emitting element driving circuit includes an analog dimming terminal and a driving terminal. The analog dimming terminal is configured to receive an analog dimming signal. The driving terminal is configured to provide a switching control signal having an operating frequency to a switching converter circuit. The switching converter circuit is configured to provide an output current to a light emitting element. The control circuit is configured to receive the analog dimming signal and to adjust the operating frequency of the switching control signal based on the analog dimming signal. The operating frequency when the analog dimming signal is at a first dimming reference is lower than the operating frequency when the analog dimming signal is at a second dimming reference. The first dimming reference is greater than the second diming reference.

### CROSS-REFERENCE TO RELATED APPLICATIONS

This application claims the benefit of and priority to a CN application 20/2311832245.6, filed on Dec. 27, 2023, which is incorporated herein by reference into the present application.

### TECHNICAL FIELD

The present disclosure relates generally to electronic circuits, and more particularly but not exclusively to light emitting element driving circuits.

### BACKGROUND OF THE INVENTION

Dimming function is often required for light emitting elements to meet different applications. As one of the light emitting elements, light emitting diode (LED) is widely used. The brightness of the LED depends on the average current flowing through the LED. Currently, there are two ways to adjust the average current flowing through the LED. One is to adjust the amplitude of the current flowing through the LED, i.e., analog dimming. The other one is to adjust the duty cycle of the pulse width modulation (PWM) signal to control the average current flowing through the LED, i.e., PWM dimming. For applications that require better dimming performance (e.g., high dimming accuracy), it is common to combine the analog dimming with the PWM dimming, i.e., hybrid dimming.

### SUMMARY OF THE INVENTION

According to an embodiment of the present disclosure, a control circuit for a light emitting element driving circuit is provided. The control circuit includes an analog dimming terminal and a driving terminal. The analog dimming terminal is configured to receive an analog dimming signal. The driving terminal is configured to provide a switching control signal having an operating frequency to a switching converter circuit. The switching converter circuit is configured to provide an output current to a light emitting element. The control circuit is configured to receive the analog dimming signal and to adjust the operating frequency of the switching control signal based on the analog dimming signal. The operating frequency when the analog dimming signal is at a first dimming reference is lower than the operating frequency when the analog dimming signal is at a second dimming reference. The first dimming reference is greater than the second diming reference.

According to another embodiment of the present disclosure, a light emitting element driving circuit is provided. The light emitting element driving circuit includes a switching converter circuit and a control circuit. The switching converter circuit is configured to provide an output current to a light emitting element. The control circuit includes an analog dimming terminal and a driving terminal. The analog dimming terminal is configured to receive an analog dimming signal. The driving terminal is configured to provide a switching control signal having an operating frequency to the switching converter circuit. The control circuit is configured to receive the analog dimming signal and to adjust the operating frequency of the switching control signal based on the analog dimming signal. The operating frequency when the analog dimming signal is at a first dimming reference is lower than the operating frequency when the analog dimming signal is at a second dimming reference. The first dimming reference is greater than the second diming reference.

According to yet another embodiment of the present disclosure, a method for controlling a switching converter circuit configured to provide an output current to a light emitting element is provided. The method includes following steps. An analog dimming signal is received. A switching control signal having an operating frequency is provided to the switching converter circuit. The operating frequency of the switching control signal is adjusted based on the analog dimming signal. The operating frequency when the analog dimming signal is at a first dimming reference is lower than the operating frequency when the analog dimming signal is at a second dimming reference. The first dimming reference is greater than the second diming reference

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 schematically shows a light emitting element driving system in accordance with one embodiment of the present disclosure.

FIG. 2 schematically shows a diagram illustrating the relationship between an operating frequency of a switching converter circuit and an analog dimming signal in accordance with one embodiment of the present disclosure.

FIGS. 3A-3B schematically show diagrams illustrating the relationship between an output current of a switching converter circuit and a pulse dimming signal at different operating frequency in accordance with one embodiment of the present disclosure.

FIG. 4 schematically shows a diagram illustrating the relationship between an operating frequency of a switching converter circuit and an analog dimming signal in accordance with another embodiment of the present disclosure.

FIG. 5 schematically shows a diagram illustrating the relationship between an operating frequency of a switching converter circuit and an analog dimming signal in accordance with yet another embodiment of the present disclosure.

FIG. 6 schematically shows a light emitting element driving system in accordance with one embodiment of the present disclosure.

FIG. 7 schematically shows a control circuit in accordance with one embodiment of the present disclosure.

FIG. 8 schematically shows a control circuit in accordance with another embodiment of the present disclosure.

FIG. 9 schematically shows a control circuit in accordance with yet another embodiment of the present disclosure.

FIG. 10 shows a flowchart of a method for controlling a switching converter circuit in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

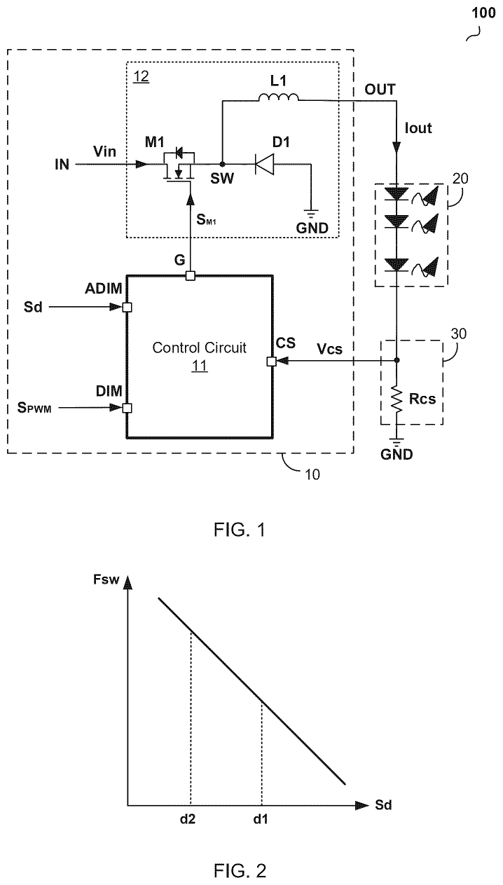

FIG. 1 shows a light emitting element driving system 100 in accordance with an embodiment of the present disclosure. The light emitting element driving system 100 includes a light emitting element driving circuit 10 and a light emitting element 20. The light emitting element 20 may include one LED, or multiple LED strings coupled in series and/or in parallel. In other embodiments, the light emitting element driving circuit 10 may also be used to drive other suitable light emitting elements, such as solid-state lighting devices.

As shown in FIG. 1, the light emitting element driving circuit 10 includes a control circuit 11 and a switching converter circuit 12. The control circuit 11 includes an analog dimming terminal ADIM, a driving terminal G, and a sense terminal CS. The analog dimming terminal ADIM is configured to receive an analog dimming signal Sd. In one embodiment, the analog dimming signal Sd is a voltage signal. The sense terminal CS is configured to receive a sense signal Vcs indicating an output current lout of the switching converter circuit 12. The control circuit 11 is configured to receive the analog dimming signal Sd and the sense signal Vcs, and to provide a switching control signal S_{M1} based on the analog dimming signal Sd and the sense signal Vcs. The switching control signal S_{M1} is provided to the switching converter circuit 12 through the driving terminal G, for controlling the operating frequency Fsw of the switching converter circuit 12. In some embodiments, the control circuit 11 is configured to receive the analog dimming signal Sd and to adjust the operating frequency Fsw of the switching converter circuit 12 based on the analog dimming signal Sd.

The switching converter circuit 12 is configured to receive an input voltage Vin and the switching control signal S_{M1}, and to provide the output current lout to the light emitting element 20 based on the input voltage Vin and the switching control signal S_{M1}. The switching converter circuit 12 includes a first power switch M1, a second power switch D1 and an inductor L1. In the embodiment of FIG. 1, the second power switch D1 is a diode. The first power switch M1 is configured to be coupled between an input terminal IN and a switching terminal SW of the switching converter circuit 12. The second power switch D1 is configured to be coupled between the switching terminal SW and a reference ground GND. The inductor L1 is configured to be coupled between the switching terminal SW and an output terminal OUT of the switching converter circuit 12. The first power switch M1 is controlled by the switching control signal S_{M1} to turn on and off alternately with the second power switch D1.

In some embodiments, the control circuit 11 is configured to provide the switching control signal S_{M1} having an operating frequency to control the switching frequency of the first power switch M1 of the switching converter circuit 12, thus to realize the control of the operating frequency Fsw of the switching converter circuit 12. In other words, the operating frequency of the switching control signal S_{M1} corresponds the operating frequency Fsw of the switching converter circuit 12. In some embodiments, the operating frequency of the switching control signal S_{M1} is equal to the switching frequency of the first power switch M1 and the operating frequency Fsw of the switching converter circuit 12.

In one embodiment, the light emitting element driving system 100 further includes a current sense circuit 30. The current sense circuit 30 is configured to detect the output current lout flowing through the light emitting element 20, and to provide the sense signal Vcs to the control circuit 11. In the embodiment shown in FIG. 1, the current sense circuit 30 includes a sense resistor Rcs coupled in series with the light emitting element 20. For instance, a first terminal of the sense resistor Rcs is configured to be coupled to the light emitting element 20, and a second terminal of the sense resistor Rcs is configured to be coupled to the reference ground GND. In other words, the sense resistor Rcs and the light emitting element 20 are coupled in series between the output terminal OUT and the reference ground GND. The output current lout flowing through the light emitting element 20 flows through the sense resistor Rcs simultaneously, and therefore the sense signal Vcs is generated to indicate the output current lout flowing through the light emitting element 20. It should be appreciated that other signals indicating the output current lout flowing through the light emitting element 20 could be used as the sense signal.

In the embodiment of FIG. 1, a BUCK topology is used as an example of the switching converter circuit 12 in the present disclosure. However, other topologies such as BOOST, BUCK-BOOST and FLYBACK may also be used in the switching converter circuit of the present disclosure. It should be appreciated that the electrical connections of power switches and energy storage devices of the switching converter circuit may be changed according to the topology of the switching converter circuit. In the embodiment of FIG. 1, the first power switch M1 is a controllable switch (e.g., MOSFET) and the second power switch D1 is a diode. It should be appreciated that, the first power switch M1 may be other suitable controllable switches, and the second power switch D1 may be replaced by a controllable switch (e.g., MOSFET) to be controlled by the switching control signal S_{M1}.

In some embodiments, the light emitting driver circuit 10 operates in an analog dimming mode. When the light emitting element driving circuit 10 operates in the analog dimming mode, the control circuit 11 provides the switching control signal S_{M1} based on the analog dimming signal Sd for controlling the switching converter circuit 12, to achieve analog dimming. For instance, when the value of the analog dimming signal Sd increases, the duty cycle of the switching control signal S_{M1} would be increased, and the on-time of the first power switch M1 is increased, therefore the amplitude of the output current lout is increased to improve the brightness of the light emitting element 20.

As shown in FIG. 1, the control circuit 11 further includes a pulse dimming terminal DIM configured to receive a pulse dimming signal S_{PWM}. In some embodiments, the pulse dimming signal S_{PWM} is a square wave signal. In some embodiments, the light emitting driver circuit 10 may operate in a PWM dimming mode. When the light emitting element driving circuit 10 operates in the PWM dimming mode, the control circuit 11 provides the switching control signal S_{M1} based on the pulse dimming signal S_{PWM} for controlling the switching converter circuit 12, to achieve PWM dimming. For example, when the pulse dimming signal S_{PWM} is at a high voltage level, the switching control signal S_{M1} transitions between a high voltage level and a low voltage level, thus the first power switch M1 and the second power switch D1 are turned on and turned off alternately to provide the output current lout. For another example, when the pulse dimming signal S_{PWM} is at a low voltage level, the switching control signal S_{M1} keeps the low voltage level, thus the first power switch M1 and the second power switch D1 are turned off to stop providing the output current lout. Therefore, the average of the output current lout of the switching converter circuit 12 could be adjusted by controlling the duty cycle of the pulse dimming signal S_{PWM}.

In some other embodiments, the light emitting element driving circuit 10 operates in a hybrid dimming mode. When the light emitting element driving circuit 10 operates in the hybrid dimming mode, the control circuit 11 provides the switching control signal S_{M1} based on the analog dimming signal Sd and the pulse dimming signal S_{PWM} for controlling the switching converter circuit 12. Typically, in hybrid dimming mode, the amplitude of the output current lout is decreased to a fixed value firstly based on the analog dimming signal Sd, and then the pulse dimming signal S_{PWM} is applied to further decrease the average of the output current lout.

FIG. 2 schematically shows a diagram illustrating the relationship between the operating frequency Fsw of the switching converter circuit 12 and the analog dimming signal Sd in accordance with one embodiment of the present disclosure. As shown in FIG. 2, the operating frequency Fsw of the switching converter circuit 12 gradually increases as the analog dimming signal Sd decreases. In one embodiment, the operating frequency Fsw of the switching converter circuit 12 increases linearly as the analog dimming signal Sd decreases. In another embodiment, the operating frequency Fsw of the switching converter circuit 12 increases by steps as the analog dimming signal Sd decreases. One of ordinary skill in the art would understand that the operating frequency Fsw of the switching converter circuit 12 may increase in other forms as the analog dimming signal Sd decreases.

The analog dimming signal Sd indicates the dimming depth of the light emitting element 20, and the dimming depth is a value indicating the brightness of the light emitting element 20. In other words, according to the actual application requirements, the brightness of the light emitting element 20 could be controlled by setting and/or adjusting the dimming depth of the light emitting element 20. The value of the dimming depth is smaller, the brightness of the light emitting element 20 is lower. In one embodiment, when the dimming depth of the light emitting element 20 is set to 100%, the brightness of the light emitting element 20 is at its highest. It should be noted that, the minimum dimming depth of the light emitting element 20 reflects the dimming range of the light emitting element 20. For example, when the dimming depth of the light emitting element 20 is in a range of 1%-100% (i.e., the light emitting element 20 has the minimum dimming depth of 1%), which means that the brightness of the light emitting element 20 could be dimmed from its highest brightness to 1% of the highest brightness.

In one embodiment, when the analog dimming signal Sd indicates that the dimming depth of the light emitting element 20 is 1%, the light emitting element driving circuit 10 may operate in the hybrid dimming mode. In this case, the amplitude of the output current lout could be decreased to a fixed value based on the analog dimming signal Sd to achieve the dimming depth of 10% firstly, and then the pulse dimming signal S_{PWM} with the duty cycle of 10% is applied, thus the dimming depth of light emitting element 20 could be further decreased to 1% (i.e., the dimming depth is further decreased to 10%*D, where D represents the duty cycle of the pulse dimming signal S_{PWM}). Therefore, the brightness of the light emitting element 20 could be decreased to 1% of the highest brightness.

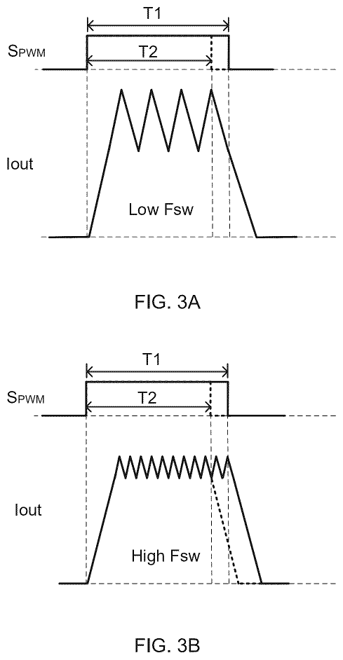

FIGS. 3A-3B schematically show diagrams illustrating the relationship between the output current lout of the switching converter circuit 12 and the pulse dimming signal S_{PWM} at different operating frequency Fsw in accordance with one embodiment of the present disclosure. As shown in FIG. 3A, when the duration of the high voltage level of the pulse dimming signal S_{PWM} decreases from T1 to T2 (i.e., the duty cycle of the pulse dimming signal S_{PWM} decreases, and the dimming depth indicated by the analog dimming signal Sd becomes smaller). When the operating frequency Fsw of the switching converter circuit 12 is at a lower value, the output current lout decreases slowly and has a falling edge with a slew rate, and therefore the waveform of the output current lout would not change as the pulse dimming signal S_{PWM} changes. In other words, the brightness of the light emitting element 20 would not change as the duty cycle of the pulse dimming signal S_{PWM} changes, and thus the dimming is not effectively performed. As a result, there is a large difference between the actual brightness and the target brightness of the light emitting element 20, and the dimming accuracy is poor.

On the other hand, as shown in FIG. 3B, when the operating frequency Fsw of the switching converter circuit 12 is at a higher value, if the output current lout has the falling edge with the slew rate, the switching converter circuit 12 may stop providing the output current lout timely. In other words, the brightness of the light emitting element 20 may change accurately and efficiently in response to the change of the pulse dimming signal S_{PWM}, thus the dimming is performed effectively. Therefore, by increasing the operating frequency Fsw, the brightness of the light emitting element 20 may be changed in time with the change of the pulse dimming signal S_{PWM}, the difference between the actual brightness and the target brightness of the light emitting element 20 becomes smaller, and thus the dimming accuracy of the light emitting element 20 is improved.

Therefore, when the light emitting element 20 is dimmed based on the pulse dimming signal S_{PWM} (e.g., the light emitting element driving circuit 10 operates in the PWM dimming mode or the hybrid dimming mode), better dimming accuracy may be achieved by gradually increasing the operating frequency Fsw of the switching converter circuit 12 as the analog dimming signal Sd decreases.

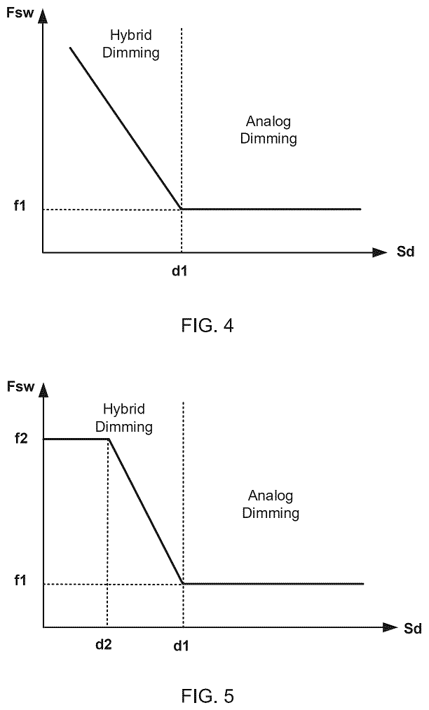

FIG. 4 schematically shows a diagram illustrating the relationship between the operating frequency Fsw of the switching converter circuit 12 and the analog dimming signal Sd in accordance with another embodiment of the present disclosure. As shown in FIG. 4, when the analog dimming signal Sd is greater than a first dimming reference d1, the light emitting element drive circuit 10 operates in the analog dimming mode based on the analog dimming signal Sd, and the operating frequency Fsw of the switching converter circuit 12 is fixed at a first fixed value f1. When the analog dimming signal Sd is less than the first dimming reference d1, the light emitting element drive circuit 10 operates in the hybrid dimming mode (i.e., PWM dimming is added) based on the analog dimming signal Sd and the pulse dimming signal S_{PWM}, the operating frequency Fsw of the switching converter circuit 12 gradually increases as the analog dimming signal Sd decreases.

FIG. 5 schematically shows a diagram illustrating the relationship between the operating frequency Fsw of the switching converter circuit 12 and the analog dimming signal Sd in accordance with yet another embodiment of the present disclosure. Compared with FIG. 4, in the embodiment of FIG. 5, when the analog dimming signal Sd decreases to be less than the second dimming reference d2, the operating frequency Fsw of the switching converter circuit 12 is fixed at a second fixed value f2. The second dimming reference d2 is less than the first dimming reference d1, and the first fixed value f1 is less than the second fixed value f2.

The values of the first dimming reference d1 and the second dimming reference d2 could be set by persons of ordinary skill in the art in accordance with specific application parameters and requirements. In one embodiment, the values of the first dimming reference d1 and the second dimming reference d2 could be set via a register. In some embodiments, the values of the first dimming reference d1 and the second dimming reference d2 could also be set by external components located outside of the IC, for example, a resistor and/or a capacitor.

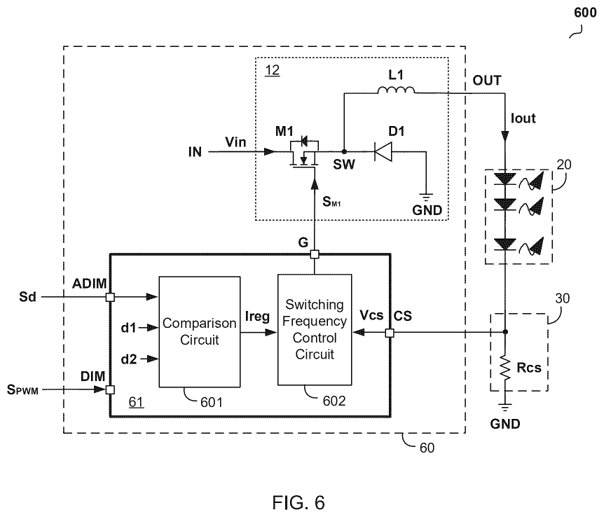

FIG. 6 schematically shows a light emitting element driving system 600 in accordance with one embodiment of the present disclosure. As shown in FIG. 6, the light emitting element driving system 600 includes a light emitting element driving circuit 60 and the light emitting element 20. The light emitting element driving circuit 60 includes a control circuit 61 and the switching converter circuit 12. The control circuit 61 includes a comparison circuit 601 and a switching frequency control circuit 602. In the embodiment of FIG. 6, the control circuit 61 is integrated in an integrated circuit (IC), which means the comparison circuit 601 and switching frequency control circuit 602 are both integrated in the same IC. In some other embodiments, the comparison circuit 601 and the switching frequency control circuit 602 are integrated dependently in different ICs.

The comparison circuit 601 is configured to receive the analog dimming signal Sd, the first dimming reference d1 and the second dimming reference d2, and to provide a current regulation signal Ireg based on the analog dimming signal Sd, the first dimming reference d1 and the second dimming reference d2. The switching frequency control circuit 602 is configured to receive the current regulation signal Ireg and the sense signal Vcs, and to provide the switching control signal S_{M1} based on the current regulation signal Ireg and the sense signal Vcs. The switching control signal S_{M1} is provided to the switching converter circuit 12 through the driving terminal G for controlling the first power switch M1, such that the switching converter circuit 12 operates at a certain operating frequency Fsw.

The working principle of the light emitting element driving system 60 is illustrated below with reference to FIGS. 5 and 6.

When the analog dimming signal Sd is greater than the first dimming reference d1, the light emitting element driving circuit 60 operates in the analog dimming mode, that is, the light emitting element 20 is dimmed based on the analog dimming signal Sd. In this case, the switching control signal S_{M1} provided by the control circuit 61 controls the switching converter circuit 12 to maintain a lower operating frequency Fsw (e.g., the first fixed value f1).

When the analog dimming signal Sd decreases to be less than the first dimming reference d1 and meanwhile greater than the second dimming reference d2, the light emitting element driver circuit 60 operates in the hybrid dimming mode (i.e., combination of both analog dimming and PWM dimming), that is, the light-emitting element 20 is dimmed based on the analog dimming signal Sd and the pulse dimming signal S_{PWM}. In this case, the switching control signal S_{M1} provided by the control circuit 61 controls the operating frequency Fsw of the switching converter circuit 12 to gradually increase as the analog dimming signal Sd decreases.

When the analog dimming signal Sd decreases to be less than the second dimming reference d2, the switching control signal S_{M1} provided by the control circuit 61 controls the switching converter circuit 12 to maintain a higher operating frequency Fsw (e.g., the second fixed value f2).

In the embodiment of the present invention, the operating frequency of the switching converter circuit is controlled based on the dimming depth indicated by the analog dimming signal. When the dimming depth is large (i.e., the brightness of the light emitting element is high and the output current provided by the switching converter circuit is large), the operating frequency of the switching converter circuit is decreased to reduce switching loss and thus to improve the efficiency. When the dimming depth is small, PWM dimming is added to achieve the hybrid dimming, and the operating frequency of the switching converter circuit is increased to achieve better dimming accuracy. In addition, when the operating frequency of the switching converter circuit is increased, the pulse dimming signal with a higher frequency (e.g., 5 kHz) could be applied to achieve dimming without reducing the dimming accuracy, and therefore flicker free could be achieved. Specifically, when the light emitting element is dimmed based on the pulse dimming signal with the higher frequency, the flickering frequency of the light emitting element is invisible to human eyes.

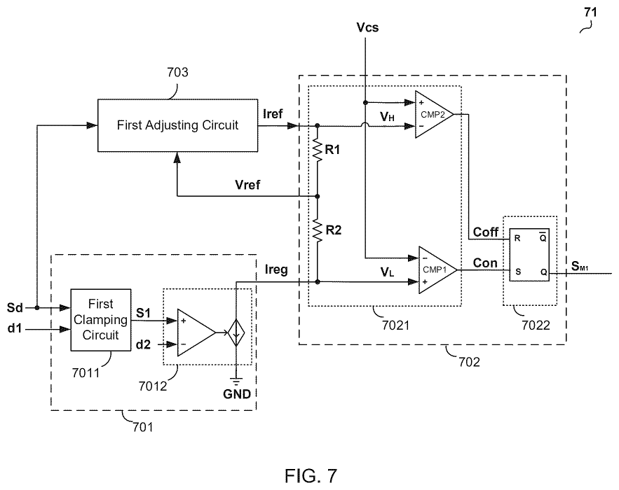

FIG. 7 shows a control circuit 71 in accordance with one embodiment of the present disclosure. The control circuit 71 includes a comparison circuit 701 and a switching frequency control circuit 702. The comparison circuit 701 includes a first clamping circuit 7011 and a first voltage-controlled current source 7012. The first clamping circuit 7011 is configured to receive the analog dimming signal Sd and the first dimming reference d1, and to provide a first clamping signal S1 based on the analog dimming signal Sd and the first dimming reference d1. When the analog dimming signal Sd is less than the first dimming reference d1, the first clamping signal S1 provided by the first clamping circuit 7011 is equal to the analog dimming signal Sd. When the analog dimming signal Sd is greater than the first dimming reference d1, the first clamping signal S1 provided by the first clamping circuit 7011 is clamped to the first dimming reference d1. In other words, the first clamping signal S1 is equal to the first dimming reference d1 when the analog dimming signal Sd is greater than the first dimming reference d1.

The first voltage-controlled current source 7012 is configured to receive the first clamping signal S1 and the second dimming reference d2, and to provide the current regulation signal Ireg based on the first clamping signal S1 and the second dimming reference d2. When the first clamping signal S1 is equal to the first dimming reference d1, the current regulation signal Ireg provided by the first voltage-controlled current source 7012 reaches a maximum value. When the first clamping signal S1 is decreased to the second dimming reference d2, the first voltage-controlled current source 7012 provided by the current regulation signal Ireg reaches a minimum value. Persons having ordinary skill in the art may understood that the first clamping circuit 7011 could be realized by other suitable circuit to achieve the clamping function.

In the embodiment of FIG. 7, the switching frequency control circuit 702 includes a hysteresis control circuit 7021 and a control signal generating circuit 7022. The hysteresis control circuit 7021 includes a resistor R1, a resistor R2, a comparator CMP1 and a comparator CMP2. The resistors R1 is coupled in series with the resistor R2, and the voltage of a connection point between the resistor R1 and the resistor R2 is a reference voltage Vref. When the resistance of the resistor R1 and the resistance of the resistor R2 are fixed, a lower threshold V_{L} and an upper threshold V_{H} of the hysteresis control circuit 7021 are determined by the current regulation signal Ireg. In some embodiments, resistors R1 and R2 has the same resistance, the hysteresis voltage width of the hysteresis control circuit 7021 is 2×ΔV, where ΔV represent a voltage across the resistor R1 or R2. In this case, by performing addition on the reference voltage Vref and the voltage across the resistor R1 (i.e., ΔV), the upper threshold V_{H} is obtained, i.e., V_{H}=Vref+ΔV; by performing subtraction on the reference voltage Vref and the voltage across the resistor R2 (i.e., ΔV), the lower threshold V_{L} is obtained, i.e., V_{L}=Vref-ΔV. Therefore, a hysteresis range V_{L}-V_{H} of the hysteresis control circuit 7021 could be adjusted by the current regulation signal Ireg.

The comparator CMP1 is configured to receive the lower threshold V_{L} and the sense signal Vcs, and to provide a turn-on control signal Con based on the lower threshold V_{L} and the sense signal Vcs. The comparator CMP2 is configured to receive the upper threshold V_{H} and the sense signal Vcs, and to provide a turn-off control signal Coff based on the upper threshold V_{H} and the sense signal Vcs. The control signal generating circuit 7022 is configured to receive the turn-on control signal Con and the turn-off control signal Coff, and to provide the switching control signal S_{M1} to turn on or turn off the first power switch M1 (not shown in FIG. 7) of the switching converter circuit 12. In the embodiment of FIG. 7, the control signal generating circuit 7022 includes a RS flip-flop. In other embodiments, the control signal generating circuit 7022 may be other suitable circuits for generating the switching control signal S_{M1}.

In one embodiment, when the sense signal Vcs decreases to the lower threshold V_{L} (i.e., Vcs<V_{L}), the comparator CMP1 provides the turn-on control signal Con with a high logic level to the set terminal of the RS flip-flop. Therefore, the RS flip-flop provides the switching control signal S_{M1} with the high voltage level to turn on the first power switch M1. When the sense signal Vcs increases to the upper threshold V_{H} (i.e., Vcs>V_{H}), the comparator CMP2 provides the turn-off control signal Coff with a high logic level to the reset terminal of the RS flip-flop. Therefore, the RS flip-flop provides the switching control signal S_{M1} with the low voltage level to turn off the first power switch M1.

As shown in FIG. 7, the control circuit 71 further includes a first adjusting circuit 703. The first adjusting circuit 703 is configured to receive the analog dimming signal Sd and the reference voltage Vref, and to provide a reference current signal Iref to the hysteresis control circuit 7021 based on the analog dimming signal Sd and the reference voltage Vref, to raise or lower the hysteresis range V_{L}-V_{H}. In one embodiment, when the reference voltage Vref is less than the analog dimming signal Sd, the first regulation circuit 703 provides the reference current signal Iref with a positive value to raise the hysteresis range V_{L}-V_{H}. For example, the hysteresis range V_{L}-V_{H} is raised from 0.75V-1.05V to 0.80V-1.10V. When the reference voltage Vref is greater than the analog dimming signal Sd, the first adjusting circuit 703 provides the reference current signal Iref with a negative value to lower the hysteresis range V_{L}-V_{H}. For example, the hysteresis range V_{L}-V_{H} is lowered from 0.75V-1.05V to 0.70V-1.00V. In one embodiment, the reference current signal Iref is less than the current regulation signal Ireg.

In summary, the comparison circuit 701 is configured to provide the current regulation signal Ireg based on the analog dimming signal Sd. The switching frequency control circuit 702 controls the hysteresis range V_{L}-V_{H} based on the current regulation signal Ireg, to change the switching frequency of the first power switch M1, and therefore changes the operating frequency Fsw of the switching converter circuit 12. When the hysteresis range V_{L}-V_{H} is larger, the operating frequency Fsw is lower. Similarly, when the hysteresis range V_{L}-V_{H} is smaller, the operating frequency Fsw is higher. The operating frequency Fsw of the switching converter circuit 12 is adjusted according to the analog dimming signal Sd as shown in FIG. 5 and will not be repeated here.

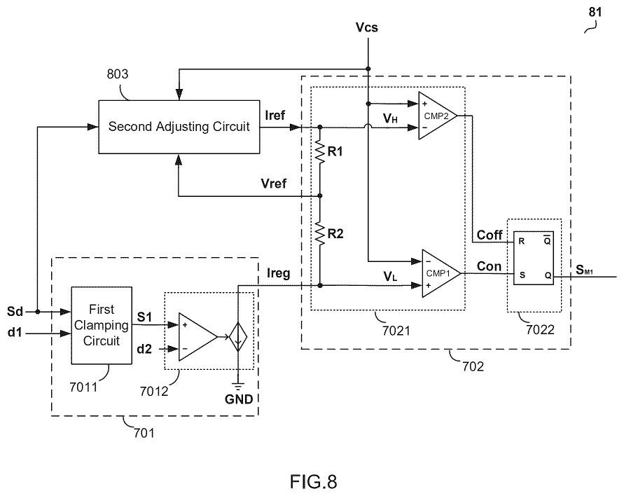

FIG. 8 schematically shows a control circuit 81 in accordance with another embodiment of the present disclosure. Compared with the first adjusting circuit 703 of FIG. 7, a second adjusting circuit 803 shown in FIG. 8 is configured to receive the analog dimming signal Sd, the sense signal Vcs and the reference voltage Vref, and to provide the reference current signal Iref to the hysteresis control circuit 8021 based on the analog dimming signal Sd, the sense signal Vcs and the reference voltage Vref, to raise or lower the hysteresis range V_{L}-V_{H}. In one implementation, when the sense signal Vcs is less than the analog dimming signal Sd, the second adjusting circuit 803 is configured to provide the reference current signal Iref with a positive value to raise the hysteresis range V_{L}-V_{H}. When the sense signal Vcs is greater than the analog dimming signal Sd, the second adjusting circuit 803 is configured to provide the reference current signal Iref with a negative value to lower the hysteresis range V_{L}-V_{H}.

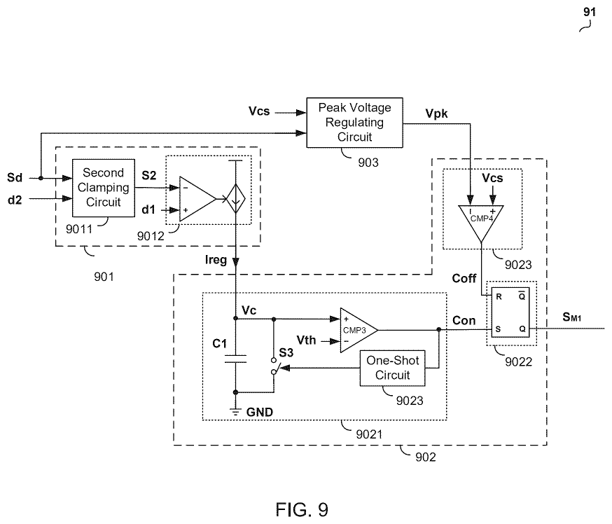

FIG. 9 schematically shows a control circuit 91 in accordance with yet another embodiment of the present disclosure. As shown in FIG. 9, the control circuit 91 includes a comparison circuit 901, a switching frequency control circuit 902 and a peak voltage regulating circuit 903. The comparison circuit 901 includes a second clamping circuit 9011 and a second voltage-controlled current source 9012. The second clamping circuit 9011 is configured to receive the analog dimming signal Sd and the second dimming reference d2, and to provide a second clamping signal S2 based on the analog dimming signal Sd and the second dimming reference d2. When the analog dimming signal Sd is greater than the second dimming reference d2, the second clamping signal S2 provided by the second clamping circuit 9011 is equal to the analog dimming signal Sd. When the analog dimming signal Sd is less than the second dimming reference d2, the second clamping signal S2 provided by the second clamping circuit 9011 is clamped to the second dimming reference d2. In other words, the second clamping signal S2 is equal to the second dimming reference d2 when the analog dimming signal Sd is less than the second dimming reference d2.

The second voltage-controlled current source 9012 is configured to receive the second clamping signal S2 and the first dimming reference d1, and to provide the current regulation signal Ireg based on the second clamping signal S2 and the first dimming reference d1. When the second clamping signal S2 is equal to the second dimming reference d2, the current regulation signal Ireg provided by the second voltage-controlled current source 9012 reaches a maximum value. When the second clamping signal S2 increases to the first dimming reference d1, the second voltage-controlled current source 9012 provided by the current regulation signal Ireg reaches a minimum value. Persons having ordinary skill in the art may understood that the second clamping circuit 9011 could be realized by other suitable circuits to achieve the clamping function.

The switching frequency control circuit 902 includes a charging control circuit 9021 and a control signal generating circuit 9022. The charging control circuit 9021 is configured to receive the current regulation signal Ireg and a threshold voltage Vth, and to provide the turn-on control signal Con based on the current regulation signal Ireg and the threshold voltage Vth. The charging control circuit 9021 includes a capacitor C1, a switch S3, a comparator CMP3 and a one-shot circuit 9023. A first terminal of the capacitor C1 is coupled to the comparison circuit 901 to receive the current regulation signal Ireg and a second terminal of the capacitor C1 is coupled to a reference ground GND. The switch S3 is coupled across the capacitor C1. When the switch S3 is turned off, the current regulation signal Ireg charges the capacitor C1 to generate a voltage Vc. The comparator CMP3 is configured to compare the voltage Vc and the threshold voltage Vth, and to provide the turn-on control signal Con based on the voltage Vc and the threshold voltage Vth. The one-shot circuit 9023 is configured to receive the turn-on control signal Con, and to turn on the switch S3 based on the turn-on control signal Con. In one embodiment, the turn-on control signal Con is provided to the control signal generating circuit 9022 after a delay time. Accordingly, the one-shot circuit 9023 is configured to turn on the switch S3 the delay time after the turn-on control signal Con is provided.

The peak voltage regulating circuit 903 is configured to receive the analog dimming signal Sd and the sense signal Vcs, and to provide a peak voltage signal Vpk based on the analog dimming signal Sd and the sense signal Vcs. In one embodiment, when the sense signal Vcs is less than the analog dimming signal Sd, the peak voltage signal Vpk increases; and when the sense signal Vcs is greater than the analog dimming signal Sd, the peak voltage signal Vpk decreases.

The switching frequency control circuit 902 further includes a peak voltage control unit 9023. The peak voltage control unit 9023 is configured to receive the peak voltage signal Vpk and the sense signal Vcs, and to provide the turn-off control signal Coff based on the peak voltage signal Vpk and the sense signal Vcs. In the embodiment of FIG. 9, the peak voltage control unit 9023 includes a comparator CMP4. When the sense signal Vcs increases to the peak voltage signal Vpk, the comparator CMP4 provides the turn-off control signal Coff.

The control signal generating circuit 9022 is configured to receive the turn-on control signal Con and the turn-off control signal Coff, and to provide the switching control signal S_{M1} based on the turn-on control signal Con and the turn-off control signal Coff. In the embodiment of FIG. 9, the control signal generating circuit 9022 is a RS flip-flop. In other embodiments, the control signal generating circuit 9022 may be other suitable circuits for generating the switching control signal S_{M1}.

As shown in FIG. 9, the value of the current regulation signal Ireg determines the charging rate of the capacitor C1. The value of the current regulation signal Ireg is greater, the charging rate of the capacitor C1 is faster, and the frequency of the turn-on control signal Con provided by the comparator CMP3 is higher, and therefore the operating frequency Fsw of the switching converter circuit 12 is higher. The operating frequency Fsw of the switching converter circuit 12 is adjusted according to the analog dimming signal Sd as shown in FIG. 5 and will not be repeated here.

It should be understood that, the circuit and the related components, circuit structures, signals, and waveforms described or shown above in the present disclosure are only for illustration purpose. However, the present disclosure is not limited thereto. Persons having ordinary skill in the art may understood that the circuit of the present disclosure could be realized, according to practical applications, by any other circuits with different circuit structures, and thus controlled by different types of the corresponding signals to achieve the corresponding functions. For example, the control circuit 11 could be realized by a digital circuit, an analog circuit, a software, or a combination of the above.

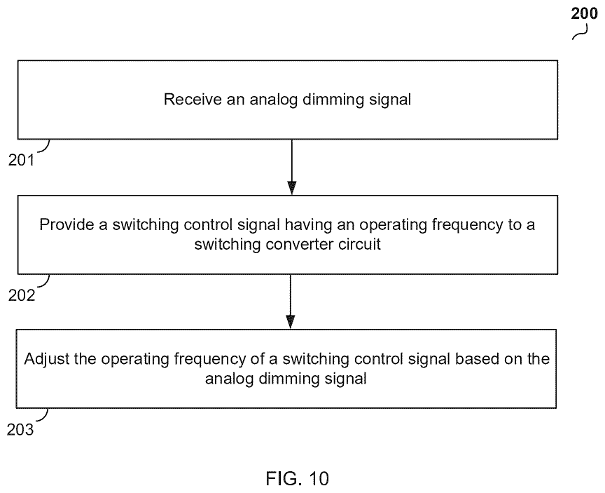

FIG. 10 show a flowchart of a method 200 for controlling a switching converter circuit in accordance with one embodiment of the present disclosure. The switching converter circuit is configured to provide an output current for a light emitting element. The method includes actions 201-203.

In action 201, an analog dimming signal is received.

In action 202, the switching control signal having an operating frequency is provided to the switching converter circuit. In some embodiments, a first power switch of the switching converter circuit is turned on and off based on the switching control signal, and the switching frequency of the first power switch corresponds to the operating frequency of the switching control signal.

In action 203, the operating frequency of the switching control signal is adjusted based on the analog dimming signal. The operating frequency when the analog dimming signal is at a first dimming reference is lower than the operating frequency when the analog dimming signal is at a second dimming reference. The first dimming reference is greater than the second diming reference.

In one embodiment, the action 203 includes the following action. The operating frequency of the switching converter circuit is increased as the analog dimming signal decreases.

In one embodiment, the action 203 includes the following actions. The operating frequency of the switching converter circuit is controlled to a first fixed value when the analog dimming signal is greater than the first dimming reference. The operating frequency of the switching converter circuit is increased as the analog dimming signal decreases when the analog dimming signal is less than the first dimming reference.

In one embodiment, the action 203 includes the following actions. The operating frequency of the switching converter circuit is controlled to the first fixed value when the analog dimming signal is greater than the first dimming reference. The operating frequency of the switching converter circuit is increased as the analog dimming signal decreases when the analog dimming signal is less than the first dimming reference. The operating frequency of the switching converter circuit is controlled to a second fixed value when the analog dimming signal is less than the second dimming reference. The first fixed value is less than the second fixed value.

It should be understood that the switching converter circuit may have different topologies. The electrical connections of devices (e.g., the first power switch and an energy storage device) of the switching converter circuit should be changed accordingly in different topologies. In one embodiment, the first power switch of the switching converter circuit corresponds to a power switch that could control the energy storage of the energy storage device of the switching converter circuit, i.e., when the power switch is turned on, the energy storage device of the switching converter circuit starts to store energy.

In one embodiment, the method 200 further includes a following action. The switching control signal is provided based on the analog dimming signal and a pulse dimming signal.

It is noted that in the flow charts described above, the functions labelled in the boxes shown in FIG. 10 can also occur in a different sequence. For example, two consecutive blocks, in fact, can be executed substantially concurrently, or they may sometimes be executed in the reverse order, depending upon the particular function involved.

In the present invention, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a light emitting element driving circuit, comprising:
an analog dimming terminal configured to receive an analog dimming signal; and
a driving terminal configured to provide a switching control signal having an operating frequency to a switching converter circuit, wherein the switching converter circuit is configured to provide an output current to a light emitting element; and wherein
the control circuit is configured to receive the analog dimming signal and to adjust the operating frequency of the switching control signal based on the analog dimming signal, and the operating frequency when the analog dimming signal is at a first dimming reference is lower than the operating frequency when the analog dimming signal is at a second dimming reference, wherein the first dimming reference is greater than the second diming reference.

2. The control circuit of claim 1, wherein when the analog dimming signal is greater than the first dimming reference, the operating frequency is at a first fixed value.

3. The control circuit of claim 2, wherein when the analog dimming signal is less than the second dimming reference, the operating frequency is at a second fixed value, wherein the first fixed value is less than the second fixed value.

4. The control circuit of claim 1, further comprising:
a pulse dimming terminal configured to receive a pulse dimming signal; wherein when the light emitting element driving circuit operates in a hybrid dimming mode, the control circuit is configured to provide the switching control signal based on the analog dimming signal and the pulse dimming signal; and
when the light emitting element driving circuit operates in an analog dimming mode, the control circuit is configured to provide the switching control signal based on the analog dimming signal.

5. The control circuit of claim 1, further comprising:
a sense terminal configured to receive a sense signal indicating the output current;
a comparison circuit configured to receive the analog dimming signal, the first dimming reference and the second dimming reference, and to provide a current regulation signal based on the analog dimming signal, the first dimming reference and the second dimming reference; and
a switching frequency control circuit configured to receive the current regulation signal and the sense signal, and to provide the switching control signal based on the current regulation signal and the sense signal.

6. The control circuit of claim 5, wherein the comparison circuit comprises:
a clamping circuit configured to receive the analog dimming signal and the first dimming reference, and to provide a clamping signal based on the analog dimming signal and the first dimming reference, wherein the clamping signal is equal to the analog dimming signal when the analog dimming signal is less than the first dimming reference, and the clamping signal is equal to the first dimming reference when the analog dimming signal is greater than the first dimming reference; and
a voltage-controlled current source configured to receive the clamping signal and the second dimming reference, and to provide the current regulation signal based on the clamping signal and the second dimming reference.

7. The control circuit of claim 5, wherein the switching frequency control circuit comprises:
a hysteresis control circuit configured to receive the current regulation signal and the sense signal, and to provide a turn-on control signal and a turn-off control signal based on the current regulation signal and the sense signal; and
a control signal generating circuit configured to receive the turn-on control signal and the turn-off control signal, and to provide the switching control signal based on the turn-on control signal and the turn-off control signal.

8. The control circuit of claim 7, further comprising:
an adjusting circuit configured to receive the analog dimming signal and a reference voltage of the hysteresis control circuit, and to provide a reference current signal to adjust an upper threshold and a lower threshold of the hysteresis control circuit based on the analog dimming signal and the reference voltage; wherein the upper threshold and the lower threshold are increased when the reference voltage is less than the analog dimming signal; and
the upper threshold and the lower threshold are decreased when the reference voltage is greater than the analog dimming signal.

9. The control circuit of claim 7, further comprising:
an adjusting circuit configured to receive the analog dimming signal, the sense signal and a reference voltage of the hysteresis control circuit, and to provide a reference current signal to adjust an upper threshold and a lower threshold of the hysteresis control circuit based on the analog dimming signal, the sense signal and the reference voltage; wherein
the upper threshold and the lower threshold are increased when the sense signal is less than the analog dimming signal; and
the upper threshold and the lower threshold are decreased when the sense signal is greater than the analog dimming signal.

10. The control circuit of claim 5, wherein the comparison circuit comprises:
a clamping circuit configured to receive the analog dimming signal and the second dimming reference, and to provide a clamping signal based on the analog dimming signal and the second dimming reference, wherein the clamping signal is equal to the second dimming reference when the analog dimming signal is less than the second dimming reference, and the clamping signal is equal to the analog dimming signal when the analog dimming signal is greater than the second dimming reference; and
a voltage-controlled current source configured to receive the clamping signal and the first dimming reference, and to provide the current regulation signal based on the clamping signal and the first dimming reference.

11. The control circuit of claim 5, wherein the switching frequency control circuit comprises:
a charging control circuit configured to receive the current regulation signal and a threshold voltage, and to provide a turn-on control signal based on the current regulation signal and the threshold voltage;
a peak voltage control unit configured to receive a peak voltage signal and the sense signal, and to provide a turn-off control signal based on the peak voltage signal and the sense signal; and
a control signal generating circuit configured to receive the turn-on control signal and the turn-off control signal, and to provide the switching control signal based on the turn-on control signal and the turn-off control signal; and wherein
the peak voltage signal is increased when the sense signal is less than the analog dimming signal; and
the peak voltage signal is decreased when the sense signal is greater than the analog dimming signal.

12. A light emitting element driving circuit, comprising:
a switching converter circuit configured to provide an output current to a light emitting element; and
a control circuit comprising:
an analog dimming terminal configured to receive an analog dimming signal; and
a driving terminal configured to provide a switching control signal having an operating frequency to the switching converter circuit; and wherein
the control circuit is configured to receive the analog dimming signal and to adjust the operating frequency of the switching control signal based on the analog dimming signal, and the operating frequency when the analog dimming signal is at a first dimming reference is lower than the operating frequency when the analog dimming signal is at a second dimming reference, wherein the first dimming reference is greater than the second diming reference.

13. The light emitting element driving circuit of claim 12, wherein when the analog dimming signal is greater than the first dimming reference, the operating frequency is at a first fixed value.

14. The light emitting element driving circuit of claim 13, wherein when the analog dimming signal is less than the second dimming reference, the operating frequency is at a second fixed value, wherein the first fixed value is less than the second fixed value.

15. The light emitting element driving circuit of claim 12, wherein the switching converter circuit comprises:
a first power switch coupled between an input terminal and a switching terminal of the switching converter circuit;
a second power switch coupled between the switching terminal and a reference ground; and
an energy storage device coupled between the switching terminal and an output terminal of the switching converter circuit; and wherein
the first power switch is turned on and turned off based on the switching control signal provided by the control circuit.

16. A method for controlling a switching converter circuit configured to provide an output current to a light emitting element, the method comprising:
receiving an analog dimming signal;
providing a switching control signal having an operating frequency to the switching converter circuit; and
adjusting the operating frequency of the switching control signal based on the analog dimming signal; and wherein
the operating frequency when the analog dimming signal is at a first dimming reference is lower than the operating frequency when the analog dimming signal is at a second dimming reference, wherein the first dimming reference is greater than the second diming reference.

17. The method of claim 16, wherein the step of adjusting the operating frequency of the switching control signal based on the analog dimming signal comprises:
increasing the operating frequency of the switching control signal as the analog dimming signal decreases.

18. The method of claim 16, wherein the step of adjusting the operating frequency of the switching control signal based on the analog dimming signal comprises:
controlling the operating frequency of the switching control signal to a fixed value when the analog dimming signal is greater than the first dimming reference; and
increasing the operating frequency of the switching control signal as the analog dimming signal decreases when the analog dimming signal is less than the first dimming reference.

19. The method of claim 16, wherein the step of adjusting the operating frequency of the switching control signal based on the analog dimming signal comprises:
controlling the operating frequency of the switching control signal to a first fixed value when the analog dimming signal is greater than the first dimming reference;
increasing the operating frequency of the switching control signal as the analog dimming signal decreases when the analog dimming signal is less than the first dimming reference; and
controlling the operating frequency of the switching control signal to a second fixed value when the analog dimming signal is less than the second dimming reference, wherein the first fixed value is less than the second fixed value.

20. The method of claim 16, further comprising:
receiving a pulse dimming signal; and
providing the switching control signal based on the analog dimming signal and the pulse dimming signal.
